(19) United States
(12) Patent Application Publication
(10) Pub. No.: US 2015/0170284 A1
(43) Pub. Date: Jun. 18, 2015

(54) DOWNSIDE RISK MANAGEMENT APPLYING COMPUTER METHODS AND SYSTEM

(71) Applicant: AlphaSimplex Group, LLC, Cambridge, MA (US)

(72) Inventors: Jeremiah Chafkin, Chestnut Hill, MA (US); Alexander Healy, Cambridge, MA (US)

(73) Assignee: AlphaSimplex Group, LLC, Cambridge, MA (US)

(21) Appl. No.: 14/108,735

(22) Filed: Dec. 17, 2013

(51) Int. Cl. G06Q 40/06

(52) U.S. Cl. CPC G06Q 40/06; G06Q 40/04

(57) ABSTRACT

A novel computer system implements an enhanced investment management approach that applies volatility data to generate a downside risk ratio. The calculations are used to support various trading/investment strategies that, when applied with select historical data, offer lower exposure and enhanced investment returns.

### CROSS REFERENCE TO RELATED PATENT APPLICATIONS

There are no earlier related applications to this patent application.

### FIELD OF INVENTION

The present invention is in the field of computer systems for investment asset management. In particular, the present invention provides novel data processing operations directed to asset volatility for computer implemented investment systems. More particularly, the present invention relates to the application of downside risk calculations in assessing investment strategies and implementing trading and hedging operations.

### BACKGROUND

Computer managed asset pools have grown in use and complexity. Managing large asset accounts and implementing select trading paradigms typically employs one or more variables calculated in real time and applied to assist in computer trading and, in particular, investment risk management.

There is a continuing desire to manage risk in making investment decisions using advanced computer systems and select algorithms. There are a number of indices in use—benchmarks for tracking performance of investments; predictive indices to guide investor selections; and indices to warn investors of potential risks in the market. These indices can be ascertained and used in a variety of ways. For example, an index can be used for managing money by either converting the index measure into a hedge ratio or as the basis of a signal where specified index levels would trigger market trading activity.

Past efforts in financial modeling of investment volatility and risk have focused on the variance or standard deviation of returns within a select investment class. Examples of this approach include the Sharpe ratio as a risk adjusted performance measure. Efforts to refine these approaches include the proposal by Markowitz (1959) to focus on the contribution to variance arising from below-average returns—defined as “semi-variance”—with this measure used in portfolio optimization. In particular, Markowitz proposed refining these notions of risk by defining “semi-variance”, i.e., the contribution to variance arising from below-average returns, and a body of work has employed this measure, especially within the context of portfolio optimization. See: Markowitz, H. M. (1959), Portfolio Selection: Efficient Diversification of Investments, Wiley, Yale University Press, 1970, Basil Blackwell, 1991. In practical applications, however, variance-based risk estimates can be overly sensitive to outliers (see, e.g., Tukey, J. W. (1960), A survey of sampling from contaminated distributions). Problems with sensitivity to outliers in the data pool can severely retard the value of these metrics.

Similar efforts at addressing volatility have been made and are found in the literature in this field. For example, see Goldstein, D. G. & Taleb, N. N. (2007). We don't quite know what we are talking about when we talk about volatility. Journal of Portfolio Management, 33(4), 84-86. See also: Kall, P. & Mayer, J. (2011). Stochastic Linear Programming: Models, Theory, and Computation. Van der Meer, R., Sortino, F. & Plantinga, A (2001). The Impact of Downside Risk on Risk-Adjusted Performance of Mutual Funds in the Euronext Markets (Jul. 19, 2001). Available at SSRN: http://ssrn.com/abstract=277352 or http://dx.doi.org/10.2139/ssrn.277352. Bawa, Vijay S. “Optimal Rules For Ordering Uncertain Prospects,” Journal of Financial Economics, 1975, v2(1), 95-121.

Several approaches have been motivated by mean-variance portfolio optimization and/or (G)ARCH modeling and therefore focus on the decomposition of variance. GARCH is an acronym from the 1980s for Generalized AutoRegressive Conditional Heteroskedasticity process, i.e., a general model of how investment returns and variance may vary over time.

While these past approaches have improved our understanding and appreciation of certain volatility related calculations, they are incomplete. These past efforts have not attempted to decompose standard deviation in a computer managed downside risk determination that results in important market risk insights—insights largely independent of any mandated optimization process. There remains a need for a more robust volatility measure that will support a computer implemented trading platform for investment tracking, trading and hedging in a coherent and successful manner.

### SUMMARY

The present invention is directed to a system and method for implementing computer derived downside risk determinations for select assets and asset classes. The invention is also directed to computer implemented calculations that are applied in conjunction with investment management operations to enhance investment performance by, inter alia, applying a measure of volatility that has a reduced sensitivity to outliers in the data set. In one arrangement, the system begins with a more robust estimate of volatility—one that applies the mean absolute deviation, i.e., the average absolute value of returns. In addition to the being less sensitive to outliers in comparison to standard deviation values, applying a mean absolute value approach provides a direct estimate of the spread of returns in the same units as standard deviation—and a simplified overall calculation for subsequent application.

In one embodiment, the inventive system provides a periodic (e.g., daily) ex ante estimate of downside risk in a historical context. The framing of this can be accomplished in several different ways; in one approach, the risk is expressed daily, e.g., “today's downside risk is higher than on 80% of days during the past 25 years.” Once the calculations are made, a computer investment system deploys the calculated risk ratios and/or indices to facilitate trading algorithms, hedging and investment management.

In accordance with this approach, downside risk ratios are calculated using realized returns to date for the security or investment of interest using select statistical calculations applied to a large historical data set of investment returns. These are then implemented by the processor to create a normalized ratio that is then applied to support selected investments. In one illustration, the calculations include: decomposing mean absolute deviation of returns into both upside and downside variables. This is similar and related to calculations known as semi-deviations. In this approach, the relative contribution of upside and downside deviation (relative to a zero return) is developed, then normalized in the context of historical data that has been developed that is reflective of investment behavior.

Varying aspects of the present invention further embrace the combination of downside risk ratios with historical investment return data to provide one or more time horizons spanning from daily, weekly, annually etc., thus effecting one or more normalized downside risk ratios from this larger data set. Application of the foregoing calculations involves a computer trading/investment platform that provides selected data input, correlation and database management. For a daily operation, system inputs are translated into the appropriate downside risk ratios expressed in percentage terms, relative to past trading days and their respective downside risk. These can be published or applied to one or more trading algorithms that target hedging or arbitrage opportunities in view of the calculated ratio.

### FIGURES OF DRAWINGS

FIG. 1 depicts a computer platform used for financial asset management useful in the context of the present invention;

FIG. 2 provides a logic flow chart depicting the logical operations of a programmed controlled processor;

FIG. 3 provides a chart of volatility of US equities (1927-2012);

FIG. 4 provides a comparison between returns and volatility;

FIG. 5 provides a chart of risk adjusted returns;

FIG. 6 depicts the historical value/trend for normalized DRRs;

FIG. 7 depicts the hypothetical investment results over time; and

FIG. 8 depicts the hypothetical investment results over select intervals.

### DETAILED DESCRIPTION

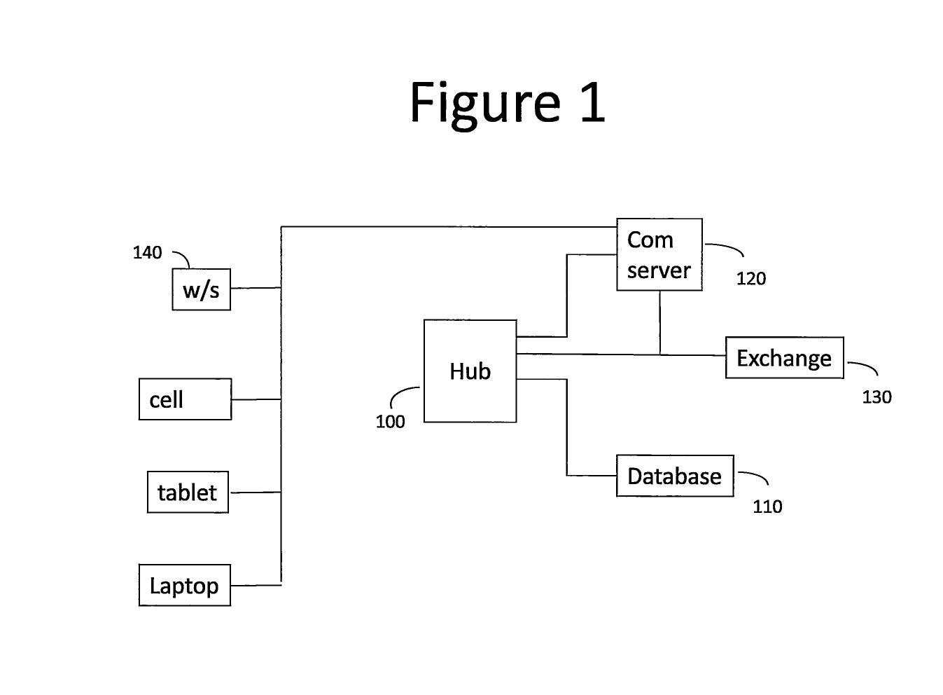

In a preferred embodiment, the system provides a computer platform as depicted in FIG. 1. In this arrangement, a processor for performing the selected calculations described herein is provided in one arrangement as part of a central hub, 100. This hub is linked to various external services that include data storage and supplemental data processing; one preferable arrangement includes a data processing hub that includes a database, 110 for data management including storage of various pricing metrics relating to the securities and investments of interest. Available database management systems include SQL servers supported by Oracle and SAP; alternatively, open source databases may be used in certain circumstances. Operative data may include historical pricing, meta data associated with such pricing and current real time market data feeds from various exchanges relevant to the volatility management operations for the system.

Continuing in FIG. 1, the computer platform is connected to network resources via Com Server 120. Appropriate server resources support the communication links to various network counterparties and/or exchanges to allow for facilitated data flow. Operations may include TCP/IP protocols and related Internet and WWW communications to provide for data entry, and remote access. In particular, assuming public trading exchanges, block 130, communications are either direct to the hub or through the appropriate server network.

Remote access is provided through the network resources and server 120; available portals for accessing and/or entering data include one or more work stations 140. While typical arrangements will include PC/MAC based computers, other work station appliances are contemplated—including mobile devices (cell phones, tablets, wifi handsets and the like). Other remote access devices can include laptops and desktop computers and flexible communication systems including game consoles handsets and various wireless apparel.

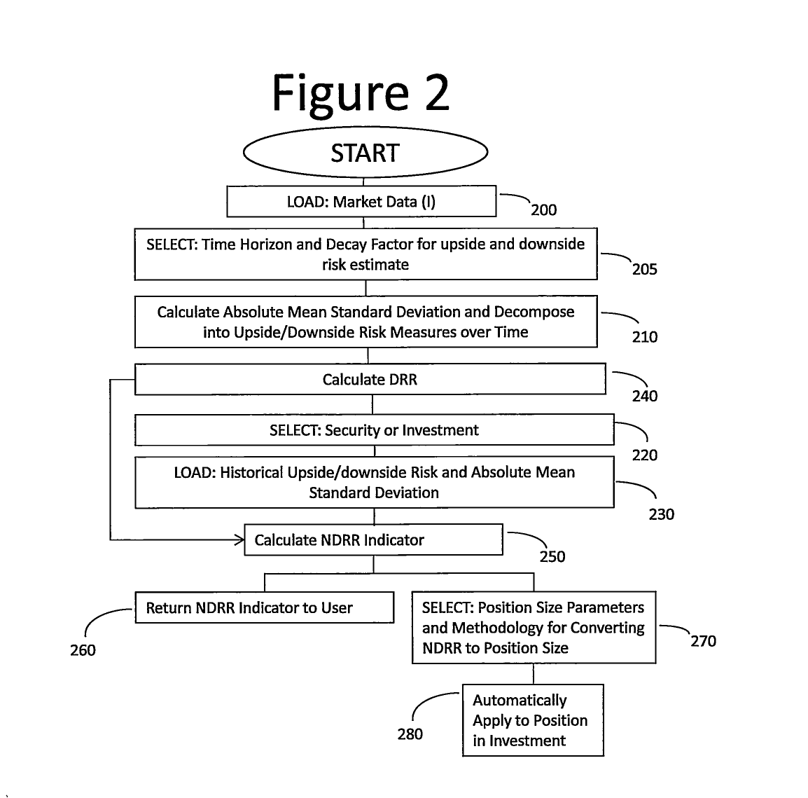

Turning now to FIG. 2, a logic diagram for the present system is presented in flowchart form. Logic conceptually begins at block 200. Operation includes data building and index/ratio calculations—including DRR and NDRR. At block 210 the system pulls the relevant data set and decomposes the volatility for the returns into both upside and downside. More precisely, for each individual security this first involves tabulating the historical daily log returns r₀, . . . , rₜ₋₁, rₜ, i.e., rᵢ=log(Pᵢ/Pᵢ₋₁) where Pᵢ is the price on day i. These returns are then processed to measure the volatility by the weighted average magnitude of daily market moves (mean absolute deviation):

$${v}_{l} = \frac{1}{1 - δ} {\sum }_{i - 0}^{∞} {δ}^{i} \vert {r}_{t} i \vert$$

where the decay parameter, δ<1, has a half-life of 3 months, i.e., δ=(½)^{1/63}.

For upside volatility, the system calculates the contribution to volatility from positive days for each security and its associated return, r:

$${u}_{t} = \frac{1}{1 - δ} {\sum }_{{r}_{t - i} > 0} {δ}^{i} \vert {r}_{l - i} \vert$$

Similarly, for the downside volatility, this is assessed from the sum of the contributions from negative return days:

$${D}_{l} = \frac{1}{1 - δ} {\sum }_{{r}_{t - i} < 0} {δ}^{i} \vert {r}_{t - i} \vert$$

Using these values, total volatility is simply the sum of the above contributions, and is expressed as follows:

Vₜ=Uₜ+Dₜ

Based on the foregoing operations, at block 240, the DRR is determined for that security in terms:

$$DRR = \frac{D}{u + D}$$

And this is calculated over time using the exponentially weighted estimates of Uₜ and Dₜ in the above formula.

The final step involves calculating the normalized DRR index—a value that ranges between 0 and 100. This is calculated by determining the percentage rank of the current DRR observation to a trailing historical window of length N days using the following:

$${NDRR}_{t} = \frac{100}{N} \cdot \vert \{ 1 \leq i \leq N \text{:} {DRR}_{t - i} \leq {DRR}_{t} \} \vert$$

A final normalized DRR is determined with N=6300 corresponding 25 years of historical return/volatility context. As discussed infra, this has resulted in a very powerful market indicator.

Continuing with FIG. 2, once the NDRR is determined, it can be simply returned to the USER as an index value and distributed as a “product” or “service” in its own right due to its intrinsic value. Alternatively, at block 270, the NDRR parameter is applied to an investment position, and controls the conversion—either hedging or expanding a select risk and/or volatility profile, block 280.

### Volatility, Downside, Upside and Risk

The financial literature has traditionally focused on the variance or standard deviation of financial returns as the primary model of return volatility and investment risk. For instance, the standard deviation of returns features prominently in risk-adjusted performance measures such as the Sharpe ratio, and portfolio variance is explicitly traded off with expected return in standard mean-variance portfolio optimization.

The present invention provides for a more robust estimate of volatility based on the mean absolute deviation, i.e., the average absolute value of returns. To support the computer implementation for these calculations, the inventive system adopts an approach based on the absolute deviation relative to the mean or median of observations, but assumes a mean of 0 and works with Eₜ[|rₜ|] where rₜ=log(1+Rₜ) is the log return at time t.

In addition to being less sensitive to outliers than the standard deviation, another virtue of the mean absolute deviation is that it directly estimates the spread of returns in the same units as standard deviation; this is in contrast to the variance, which is non-linearly related to volatility (since it is the square of the standard deviation). This allows for a particularly clean analog of semi-variance, where we define upside and downside volatility of log returns r₁, . . . , rₙ by:

U=Eₜ[max(+rₜ, 0)] and D=Eₜ[max(−rₜ, 0)],

and observe that the quantity V defined by:

V=U+D=Eₜ[|rₜ|]

V reflects the mean absolute deviation of returns, i.e., an estimate of market volatility. This, in part, demonstrates the benefit of comparing returns to 0, rather than to the sample mean or median. While it is possible to define: D=Eₜ[max(−(rₜ−m),0)] and U=Eₜ[max(rₜ−m,0)], where m is the mean of returns rₜ, this reduces to U=D=V/2, a circular and thus less valuable result. In addition, once provided with the appropriate normalizations, the above determinations can be adapted to data at a variety of time horizons, e.g., daily, weekly, monthly, etc. It is generally preferred to operate using daily returns.

Given certain assumptions, volatility estimates can be annualized by multiplying the daily volatility by \sqrt{(126)π}. Indeed, assuming that daily log returns are normally distributed with a mean=0 and standard deviation =σ; and there are 252 days in each year,

σ°\sqrt{252}=E∥r∥\sqrt{126π}

and so this annualization is justified if daily log returns are approximately normally distributed. This provides a convenient way to express estimates of total volatility, upside volatility and downside volatility in a manner comparable to the more conventional measure of annualized standard deviations of returns.

### EXAMPLE

The above principles may be more easily understood in the context of an illustration. An analysis of the daily for U.S. equities from 1927 through 2012 reveals the following market attributes (annualized, as described above):

Average Upside Volatility U=7.18%

Average Downside Volatility D=6.49%

Average Total Volatility V=U+D=13.67%

Accordingly, 52.5% of the volatility is upside, consistent with the positive risk premium enjoyed by equities over the long run.

### Weighted Estimates of Downside and Upside

The above derivation of upside/downside volatility focused on the case where equal weight is given to all return observations, i.e., V=Eₜ[|rₜ|]. However, enhanced performance may be achieved by applying different weights to each of the return observations:

w₀, w₁ . . . wₖ where Σᵢwᵢ=1,

Several alternative weighting algorithms may be used. The weighted volatility estimate at time t by:

Vₜ=Σᵢwᵢ·|rₜ₋ᵢ|

with the corresponding decomposition into upside and downside volatility:

Uₜ=Σᵢwᵢ·max(+rₜ₋ᵢ, 0)

Dₜ=Σᵢwᵢ·max(−rₜ₋ᵢ, 0)

so that Vₜ=Uₜ+Dₜ, as before. A particularly useful approach is to choose weights, wᵢ that are exponentially decaying in i, in order to give more weight to recently observed returns, i.e., wᵢ=δⁱ/(1−δ) for a suitable decay parameter 0<δ<1.

### The Downside Risk Ratio

The decomposition of volatility into upside and downside volatility allows us to not only quantify how volatility varies over time, but also how the relative contributions of upside and downside volatility vary over time. The particular quantity we shall focus on is the fraction of total volatility that can be attributed to downside volatility, i.e.,

$${DRR}_{t} = \frac{{D}_{t}}{{U}_{t} + {D}_{t}} = \frac{{D}_{t}}{{V}_{t}}$$

As determined above, this value is known as the downside risk ratio (DRR) at time t. As Uₜ and Dₜ are both nonnegative, DRRₜ takes on a value in the interval [0, 1], and for many financial time series the average value of DRRₜ over long horizons is approximately ½, but can vary considerably depending on: (i) the return series in question, (ii) the choice of weights and (iii) the particular market conditions preceding time t.

### A Normalized Downside Risk Index

In order to quantify whether the current downside risk ratio, DRRₜ, is typical or particularly elevated relative to historical experience, it is natural to compare the current DRR to its historical distribution over a sufficiently long period that is likely to contain a variety of representative market environments, e.g., 25 years. To this end, we define the N-period normalized downside risk ratio at time t, NDRRₜ,

$${NDRR}_{t} = \frac{100}{N} \cdot \vert \{ 1 \leq i \leq N \text{:} {DRR}_{t - i} \leq {DRR}_{t} \} \vert$$

Thus, for example, we may choose N =25·252=6300 to normalize a daily DRR measure based on the last 25 years of daily observations. By construction, the normalized DRR index is in the range [0, 100] and lends itself immediately to interpretation: a value of 68 means that the current level of DRRₜ is at least as large as it has been on 68% of days over the preceding 25 years.

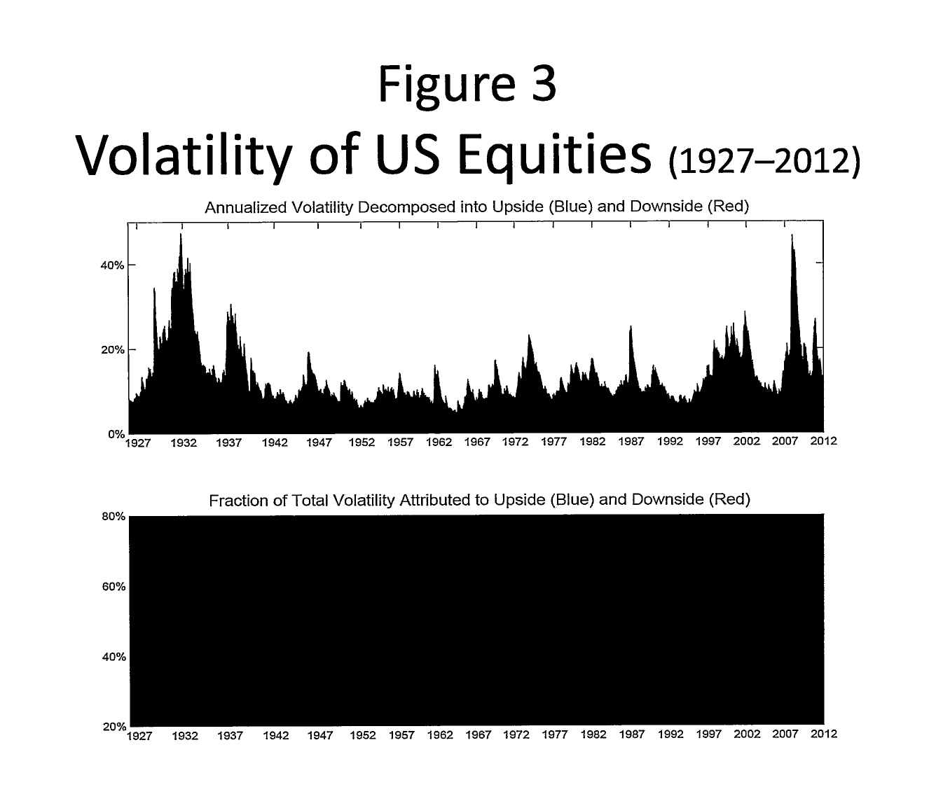

As noted, volatility is an important investment analytical tool and FIG. 3 summarizes volatility in the U.S. equity market for an 85 year span. As depicted, the volatility (top panel of FIG. 3) is decomposed into both upside and downside components using the methodology described above. The bottom panel of FIG. 3 shows the corresponding DRR over the same time period.

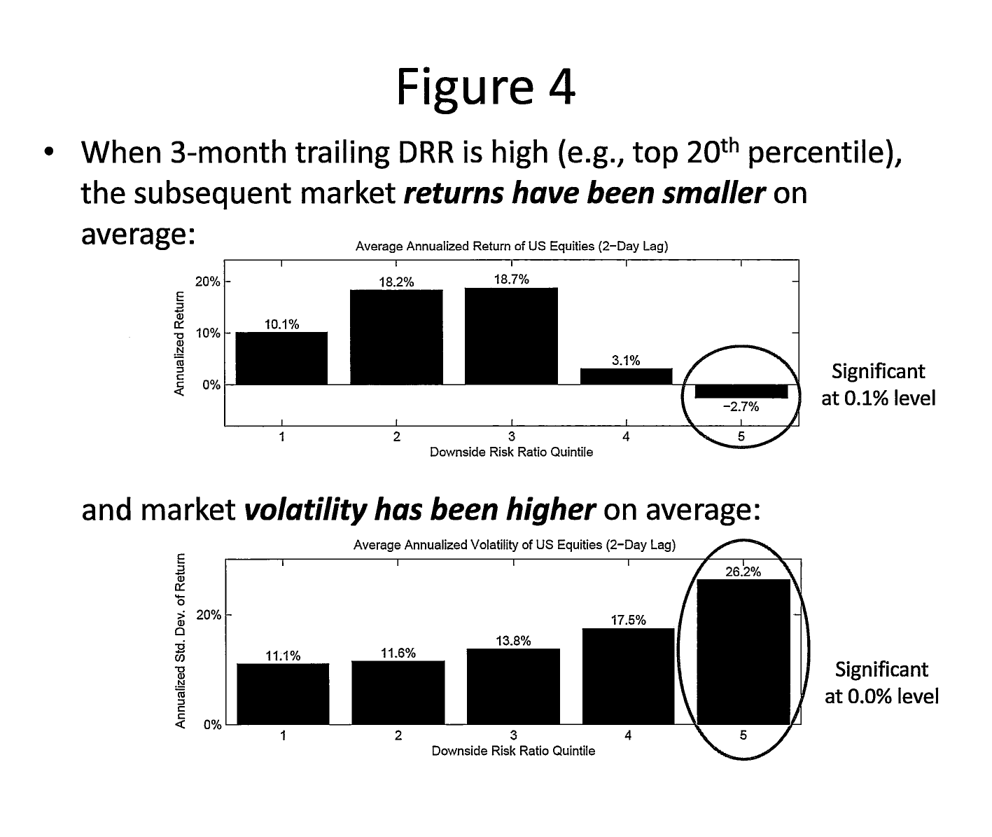

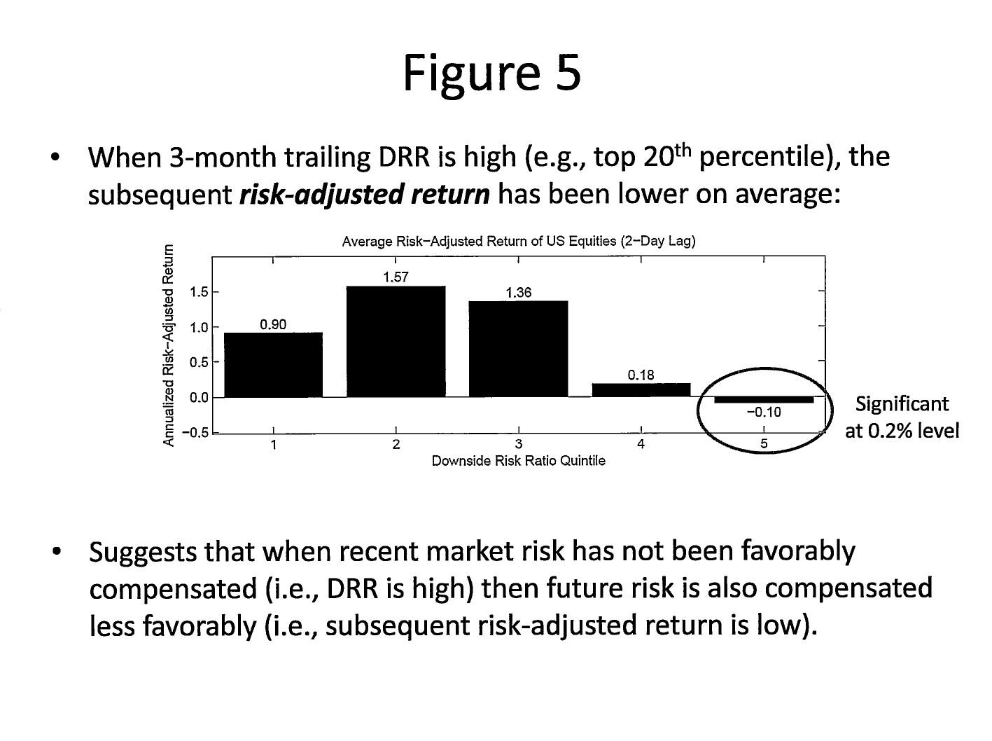

These calculations are positively associated with significant predictions. For example, in FIG. 4, the DRR provides a meaningful prediction of future risk, as a high DRR result in smaller market returns, and higher volatility. Taken together, this indicates a lower risk-adjusted average return, as shown in FIG. 5.

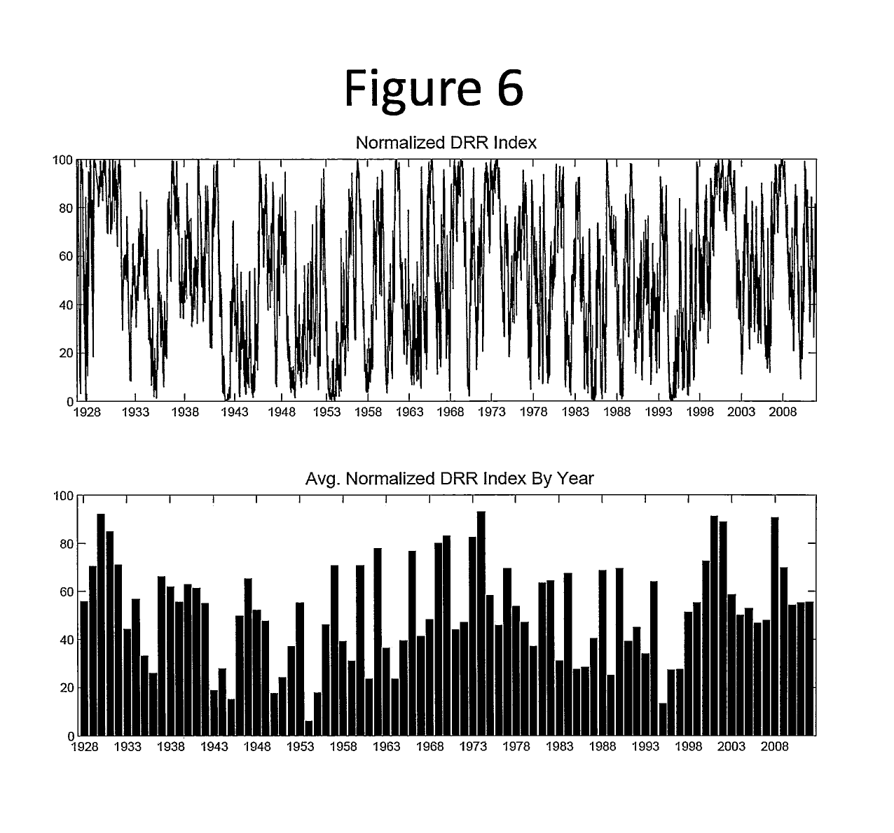

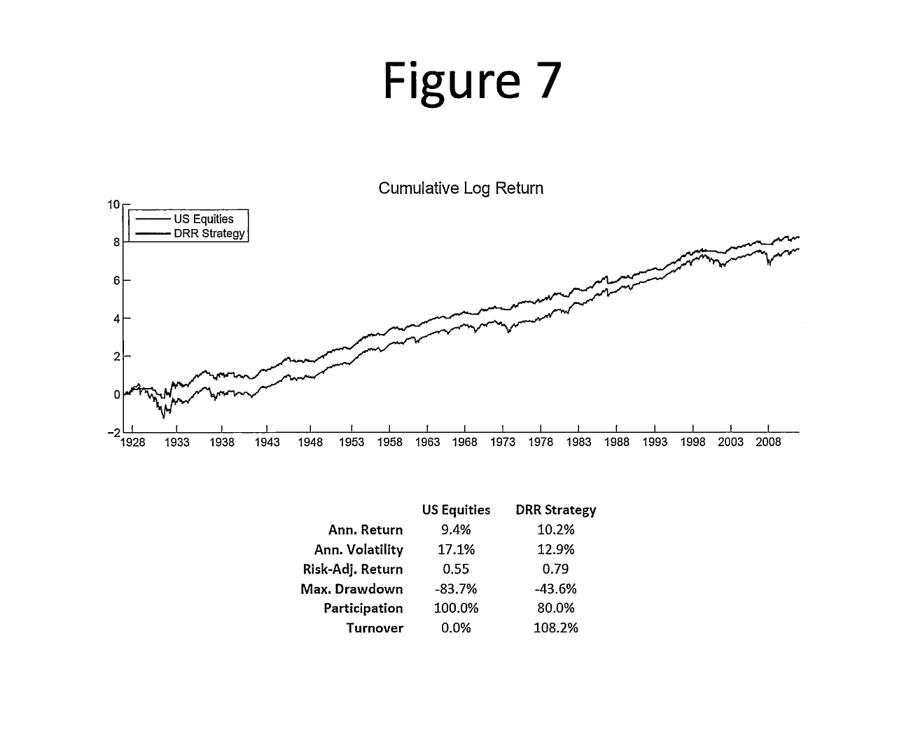

FIG. 6 presents the normalized DRR for the same time period, presented in bar chart form by year. Continuing with FIG. 7, a simple NDRR strategy is presented and has two rules:

1. Default: 100% investment in equities.

2. If NDRR over last ten days is over 80, then go flat until 10 day average NDRR drops below 80.

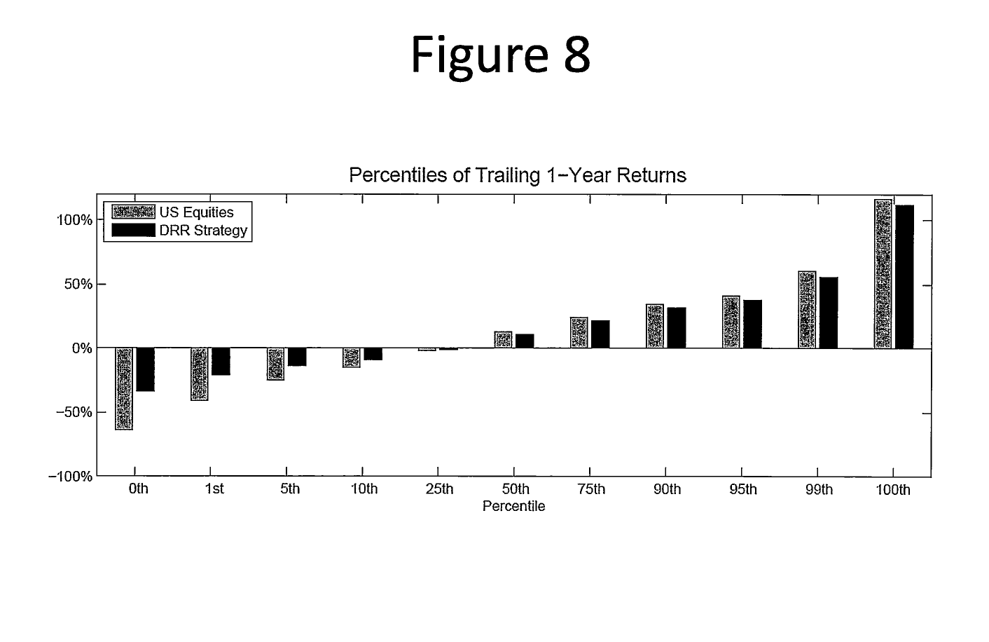

Applying this NDRR based investment strategy provides a significantly better investment performance when tracked on a historical basis. Taken one step further, as reflected in FIG. 8, selectively reducing market exposure reduces the extremes (both positive and negative). During the sample period (1927-2012), the average improvement in negative returns is more pronounced than the average reduction in positive returns.

More generally, the indicators described above may be used to determine the desired position size (or market beta or market exposure) in an appropriate investment. For example, to apply the NDRR indicator to a given investment/instrument, a user may begin by specifying a maximum and minimum permissible position size as a percentage of capital. For example, an investor in large cap U.S. stocks that is unwilling to avail himself of leverage might choose 100% of capital as the maximum exposure to the S&P 500, Russell 1000, or other large cap U.S. equity index and 0% of capital as the minimum exposure. Once these limits have been established, the user may specify a methodology for determining incremental changes in market exposure within these limits. There are many possible methods that could be specified for this purpose and two examples are given below: 1) a step-function such that market exposure is constant within a pre-specified range of values for the indicator; and 2) a continuous function such that every change in the indicator translates to a change in desired market exposure.

### Example 1

Minimum and maximum market exposure limits of 0% and 120% of capital respectively. The user may assign a desired market exposure within these limits to each of several ranges for the DRR indicator, e.g.:

If the indicator is between 0 and 50, then target market exposure=120%

If the indicator is between 50 and 65, then target market exposure=100%

If the indicator is between 65 and 80, then target market exposure=50%

If the indicator is above 80, then target market exposure=0%.

Example 2

Minimum and maximum market exposure limits of 0% and 200% of capital respectively. Within these limits the user might derive the desired market exposure by multiplying the indicator value by 2 and subtracting the product from 200%. Thus, e.g.:

If the indicator value is 20, then target market exposure=160%

If the indicator value is 50, then target market exposure=100%

If the indicator value is 80 then target market exposure=40%, etc.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and also to enable any person skilled in the art to practice certain implementations of the disclosed technology, including making and using any devices or systems and performing any incorporated methods. The invention is not limited to these disclosures but embraces modifications and enhancements thereof consistent with the claims.

1. A selectively programmed computer system for implementing risk management, comprising;
a. A user interface for selective review of data output and entry into one or more trading platforms;
b. A program-controlled processor supporting said user interface, wherein said processor is programmed to implement a review of current market conditions and historical pricing data and to estimate one or more values corresponding to a measure of downside risk associated with current market conditions relative to a measure of downside risk associated with past market conditions, based on said historical data;
c. A communication link to allow rapid access to the one or more estimated values corresponding to downside risk and to apply said one or more estimated values to a trading protocol that applies said one or more estimated values in securities trading; and
d. A database interconnected to said program-controlled processor for select data storage associated with said developed one or more estimated values.

2. The computer system of claim 1 wherein said review is based on a statistical evaluation of historical returns for a select investment, where the evaluation applies a calculation of returns for said investment over a specified interval and decomposes said returns into upside and downside volatility values.

3. The computer system of claim 2 wherein a predetermined weighted factor is applied to said upside and downside volatilities for said historical returns.

4. The computer system of claim 3 wherein said weighted factor is exponentially biased towards more recent returns.

5. The computer system of claim 1 wherein said database is populated with trading data collected from exchanges over a communication network.

6. The computer system of claim 5 wherein said downside risk parameter is applied to one or more investments to implement a volatility based trading strategy.

7. The computer system of claim 6 wherein said downside risk parameter is normalized to range between 0 and 100 based on a historical range of said downside risk parameter.

8. A computerized method for determining a downside risk ratio that corresponds to a measure of risk relative to historical risks in price changes associated with select securities, said method comprising:
a. Accessing a database of historical returns that have been selectively organized to provide a working record;
b. Calculating, by a processor, a series of decomposed upside and downside volatility values, wherein the decomposed upside volatility values comprise positive values corresponding to volatility of an investment when the investment increases in value and the decomposed downside volatility values comprise positive values corresponding to volatility of an investment when the investment decreases in value;
c. Determining a downside risk ratio based on the series of decomposed upside and downside volatility values; and
d. Distributing said downside risk ratio to one or more trading platforms for enhanced investment decisions.

9. The method of claim 8 wherein the downside risk ratio is normalized to range between 0 and 100 after said determining step (c).

10. The method of claim 8 wherein the ratio is determined from the historical returns of the securities making up the S & P 500 index.

11. The method of claim 8 further comprising the step of adjusting one or more investment exposure based on said ratio.

12. The method of claim 8 wherein the determining step further provides the calculation of Mean Absolute Deviations (MAD) of said historical investment returns.

13. The method of claim 12 wherein the determining step includes applying weighted averaging to historical return data.

14. A computer controlled investment trading system, comprising:
a. A trading platform connected to one or more securities markets for select investments;
b. A processor programmed to receive data, regarding historical returns and to convert these returns into a downside risk ratio (DRR);
c. An output processor for converting said DRR into one or more risk adjusting trading instructions and communicating said instructions to said securities markets.

15. The trading system of claim 14, further comprising a communication link to one or more databases for selective creation of a historical data set to be applied by said processor.

16. The trading system of claim 15 wherein said DRR is calculated by determining the mean absolute deviation of said historical data set.

17. The trading system of claim 16 wherein the DRR is used to hedge an investment position.

18. The trading system of claim 14 wherein the output processor sends purchase or sale orders for one or more equity or derivative securities.

19. The trading system of claim 15 wherein said DRR is normalized (NDRR) and distributed to subscribers.

20. The trading system of claim 19 wherein said updated NDRR are distributed to subscribers on a daily basis.
